(19) United States
(12) Patent Application Publication
(10) Pub. No.: US 2004/0011176 A1
(43) Pub. Date: Jan. 22, 2004

(54) Cutting machine having aligned dual spindles

(76) Inventor: Kazuma Sekiya, Tokyo (JP)

Correspondence Address: David T. Nikaido, RADER, FISHMAN & GRAUER, PLLC, Suite 501, 1233 20th Street, NW, Washington, DC, 20036, US

(21) Appl. No.: 10/021,026

(22) Filed: Dec. 19, 2001

(30) Foreign Application Priority Data
Jan. 19, 2001 (JP) 2001-11548

(51) Int. Cl. B26D 7/06; B26D 3/08

(52) U.S. Cl. 83/401; 83/884; 83/425.3

(57) ABSTRACT

Disclosed is a cutting machine including at least a chuck table for fixedly holding a workpiece to be diced, an X-axial feeder means for feeding the chuck table bearing the workpiece thereon in the X-axial direction, and first and second cutting means each having a spindle arranged in Y-axial direction, perpendicular to the X-axial direction. The first and second cutting means are so arranged that the rotary axes of the spindles may be aligned with each other with their rotary blades facing each other. Each rotary blade comprises a circular cutting blade having an annular hub integrally connected to one side. Each spindle has the rotary blade mounted with its hub directed inside, leaving no projection outside, thus permitting each cutting blade to face the counter cutting blade without anything intervening therebetween. This arrangement permits the counter rotary blades to get close to each other, permitting them to be aligned with two adjacent streets running at a minimum interval on the workpiece.

### BACKGROUND OF THE INVENTION

1. Field of the Invention

The present invention relates to a cutting machine for use in dicing a workpiece such as a semiconductor wafer, particularly a dual-spindle type of cutting machine having two confronting spindles each having a rotary blade attached to its mount end.

2. Related Arts

Referring to FIGS. 6A and 6B, a cutting machine is equipped with cutting means 70, which comprises a spindle 23 rotatably supported in a spindle housing 22, and a rotary blade 24 attached to the male-threaded, collared mount end 23a of the spindle 23. Specifically the rotary blade 24 comprises a cutting blade 24b having a circular hole made at its center, and an annular hub 24a integrally connected to the circumference of the center hole of the cutting blade 24b. The rotary blade 24 is applied to the mount end 23a of the spindle 23 with the cutting blade 24b facing the mount end 23a so that the cutting blade 24b may abut on the mount collar 23a, allowing the male-threaded end 23b to project from the annular hub 24a, and then, a female-threaded nut 27 is tightened around the male threaded end 23b of the mount end 23a to sandwich the rotary blade 24 between the nut 27 and the mount end 23a.

Referring to FIG. 7, two cutting means 70 are arranged with their axes aligned in confronting relation in the dual-spindle type of cutting machine.

This arrangement permits two cutting blades to simultaneously cut the workpiece in cutting, and accordingly the cutting machine can work at an increased efficiency, compared with a single-spindle type of cutting machine.

In a case where a semiconductor wafer is cut into small chamfered squares one of the cutting blades is used in making “V”-shaped grooves at regular intervals in the workpiece while the other cutting blade is used in cutting deep in the “V”-shaped grooves to separate the workpiece into chamfered squares.

As seen from FIGS. 6(A) and (B), the rotary blade structure 24 comprising the cutting blade 24b, the annular hub 24a and the nut 27 has a substantial thickness on one side, and accordingly the blade-to-blade distance L1 remains a significant elongated length even when the counter rotary blades 24 are put close to each other, as seen from FIG. 7.

Referring to FIG. 8, the street-to-street distance D in the semiconductor wafer W is several millimeters long, and the blade-to-blade distance L1 is longer than the street-to-street distance D, say five times longer than the street-to-street distance D in the example as shown in the drawing. Therefore, two streets which can be simultaneously cut are five streets apart.

For this reason in cutting the first to five streets at the outset of the dicing in one direction, and in cutting the last to the last-but-four streets in the semiconductor wafer W one of the cutting blades is permitted to work while the other cutting blade remains dormant. Accordingly, the cutting machine works at a reduced efficiency.

### SUMMARY OF THE INVENTION

One object of the present invention is to provide a cutting machine enabling its counter rotary blades to get so close to each other that they may be aligned with adjacent parallel cutting lines arranged at a minimum interval on a workpiece. Thus, two counter blades can be used simultaneously all the time.

To attain this object, a cutting machine comprising at least a chuck table for fixedly holding a workpiece to be cut, X-axial feeder means for feeding the chuck table bearing the workpiece thereon in the X-axial direction, and first and second cutting means each having a spindle arranged in the Y-axial direction perpendicular to the X-axial direction, said first and second cutting means being so arranged that the rotary axes of the spindles may be aligned with each other with their rotary blades facing each other, is improved according to the present invention in that: each rotary blade comprises a circular cutting blade having an annular hub integrally connected to one side; each spindle has the rotary blade mounted with its hub directed inside, leaving no projection outside, thus permitting each cutting blade to face the counter cutting blade without anything intervening therebetween; and the cutting machine further comprises water-jet nozzle means in the vicinity of the rotary blade.

This arrangement permits the counter rotary blades to get close to each other, permitting them to be aligned with two adjacent streets running at a minimum interval. Thus, two counter rotary blades can be used simultaneously all the time. Water-jet nozzle means is so positioned in the vicinity of the rotary blades that the adjusting of the blade-to-blade distance may not be interfered by the water-jet nozzle.

The cutting machine may further include blade defect detecting means comprising light emitting and light receiving elements so placed on the side of the hub of each rotary blade that the beam of light from the light emitter may reach the light receiver after being reflected from the cutting blade. The light emitting and light receiving elements are so placed on the side of the hub of each rotary blade that the adjusting of the blade-to-blade distance may not be interfered by the water-jet nozzle.

Other objects and advantages will be understood from the following description of a cutting machine according to one preferred embodiment of the present invention, which is shown in accompanying drawings.

### BRIEF DESCRIPTION OF THE DRAWING

FIG. 1 is a perspective view of a cutting machine according to the present invention;

FIG. 2 is a plane view of a semiconductor wafer to be diced;

FIG. 3 is a perspective view of the major part of the cutting means of the cutting machine;

FIG. 4(A) is an exploded view of the cutting means whereas FIG. 4(B) is a perspective view of the cutting means comprising the spindle having the rotary blade fastened thereto with the nut;

FIG. 5 illustrates how two cutting means are arranged in dicing the semiconductor wafer;

FIG. 6(A) is an exploded view of a conventional cutting means whereas FIG. 6(B) is a perspective view of the conventional cutting means comprising the spindle having the rotary blade fastened thereto with the nut;

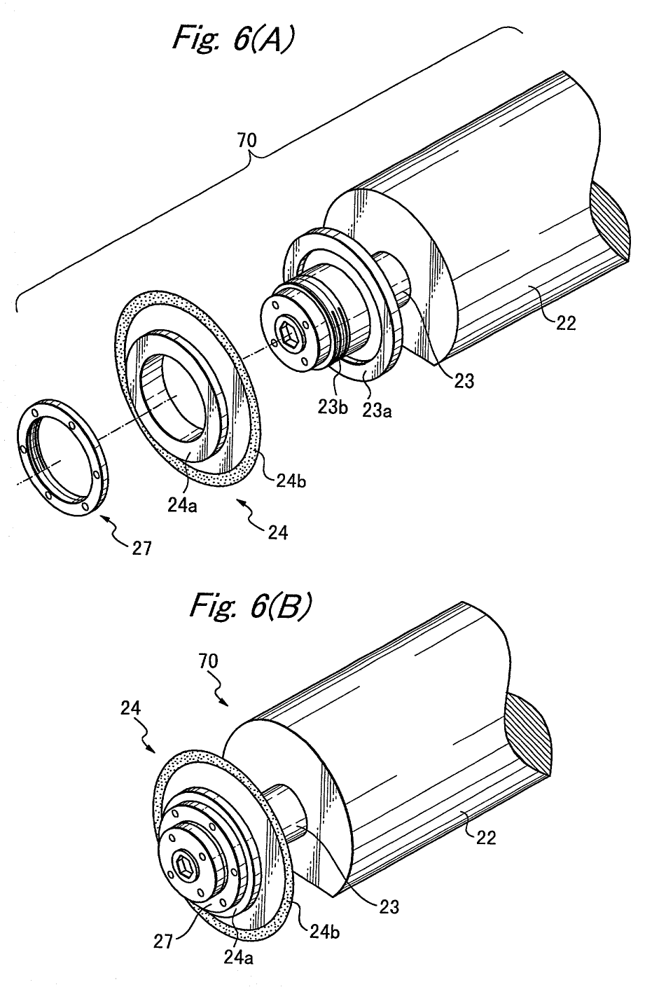

FIG. 7 illustrates the conventional counter cutting means arranged in confronting relation; and

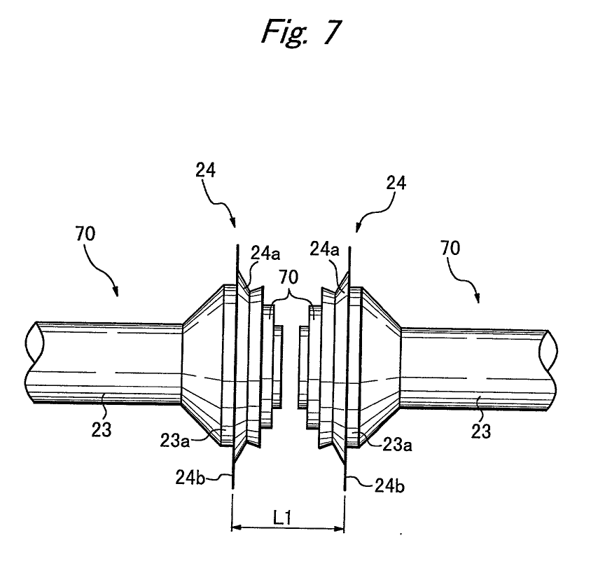

FIG. 8 illustrates how and why the counter cutting means cannot be used simultaneously at the outset and termination of the dicing operation.

### DETAILED DESCRIPTION OF PREFERRED EMBODIMENT

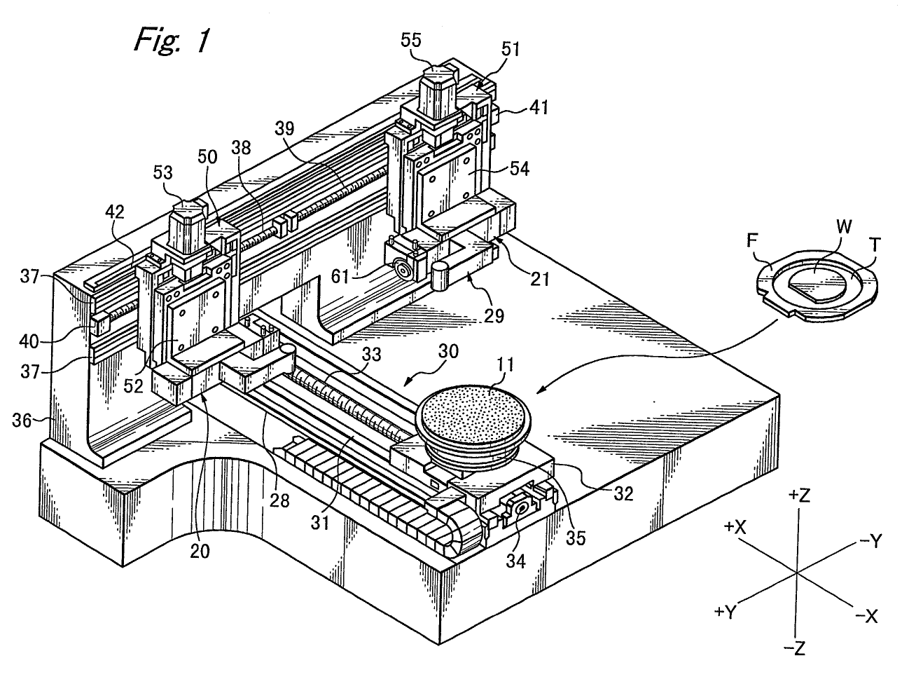

Referring to FIG. 1, a cutting machine 10 is of the dual-spindle type, in which the first and second cutting means 20 and 21 can be moved both in the Y-axial direction (indenting direction) and in the Z-axial direction (cutting-in direction), and the chuck table 11 sucking and holding a workpiece thereon can be moved in the X-axial direction (cutting-and-feeding direction).

In dicing a semiconductor wafer W, it is attached to a frame F via a piece of adhesive tape T, and then the wafer-and-frame set is fixedly held on the chuck table 11 by applying a negative pressure to the set.

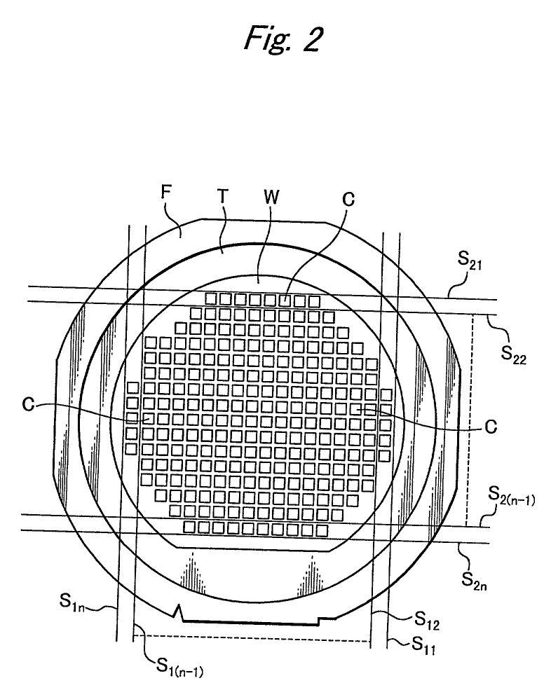

Referring to FIG. 2, the semiconductor wafer W has a lattice pattern formed thereon. It is composed of crosswise-arrangement of streets S₁₁ to S₁ₙ and S₂₁ to S₂ₙ, and each square C has a circuit pattern formed thereon. A plurality of semiconductor chips C can be provided by dicing the semiconductor wafer W into squares.

Referring to FIG. 1 again, the chuck table 11 can be driven in the X-axial direction by the cutting-and-feeding means 30. The first alignment means 28 is integrally connected to the first cutting means 20, and the second alignment means 29 is integrally connected to the second cutting means 21. These alignment means can detect which street to be cut on the semiconductor wafer W, permitting the rotary blade 24 to be put in alignment with the so detected street on the Y-axis. Then, the cutting operation starts.

The cutting-and-feeding means 30 comprises an X-axial guide rail 31, an X-axial movable base 32 having a female-threaded nut (not shown) integrally connected thereto, an X-axial screw rod 33 threadedly engaged with the nut of the X-axial movable base 32 and an X-axial stepping motor 34. The chuck table 11 is rotatably mounted to a support base 35, which is fixed to the X-axial movable base 32. Stepwise-rotation of the stepping motor 34 rotates the screw rod 33, thereby moving the chuck table 11 in the X-axial direction.

An arch-like wall 36 stands in the Y-axial direction to allow the chuck table 11 to pass through the space between its opposite supports. The wall 36 has a Y-axial guide rail 37 laid thereon, and first and second support blocks 50 and 51 each having a nut integrally connected thereto ride on the Y-axial guide rail 37 slidably.

The wall 36 has first and second screw rods 38 and 39 arranged in confronting relation with their axes aligned, and the first and second support blocks 50 and 51 are operatively connected to the first and second screw rods 38 and 39 with their nuts threadedly engaged with the screw rods 38 and 39.

The first screw rod 38 is connected at one end to a Y-axial stepping motor 40 whereas the second screw rod 39 is connected at one end to another Y-axial stepping motor 41. Rotation of the respective stepping motor 40 or 41 permits the first or second support block 50 or 51 to move independently in the Y-axial direction.

A linear scale 42 is laid along the linear alignment of first and second screw rods 38 and 39 to determine the position of the first or second support block 50 or 51 for controlling their positions in the Y-axial direction with accuracy. Two linear scales may be allotted to the first and second screw rods 38 and 39 for determining their positions on the Y-axis, but the accuracy may be lowered more or less when two separate linear scales are used.

The first support block 50 has a first lift 52 attached thereto, and the lift 52 bearing the first cutting means 20 can be driven vertically in the Z-axial direction by an associated Z-axial stepping motor 53. Likewise, the second support block 51 has a second lift 54 attached thereto, and the lift 54 bearing the second cutting means 21 can be driven vertically in the Z-axial direction by an associated Z-axial stepping motor 55. The vertical stroke of the first or second lift 52 or 54 can be adjusted so as to control the depth which the cutter blade cuts into the thickness of the semiconductor wafer W.

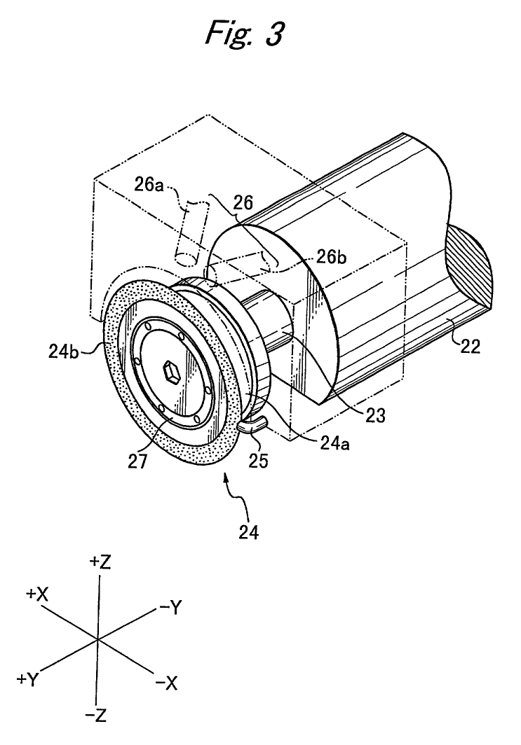

Referring to FIG. 3, the major part of the first cutting means 20 is shown at large scale. The first spindle 23 is rotatably supported in the first spindle housing 22, extending in the Y-axial direction, and the first rotary blade 24 is fixed to the first spindle 23. As shown, a water-jet nozzle 25 is placed behind the first rotary blade 24 in the vicinity of the circular circumference of the rotary blade 24. Likewise, light emitting and receiving elements 26a and 26b are arranged behind the first rotary blade in the vicinity of the circular circumference of the rotary blade 24, making up a blade defect detecting means 26.

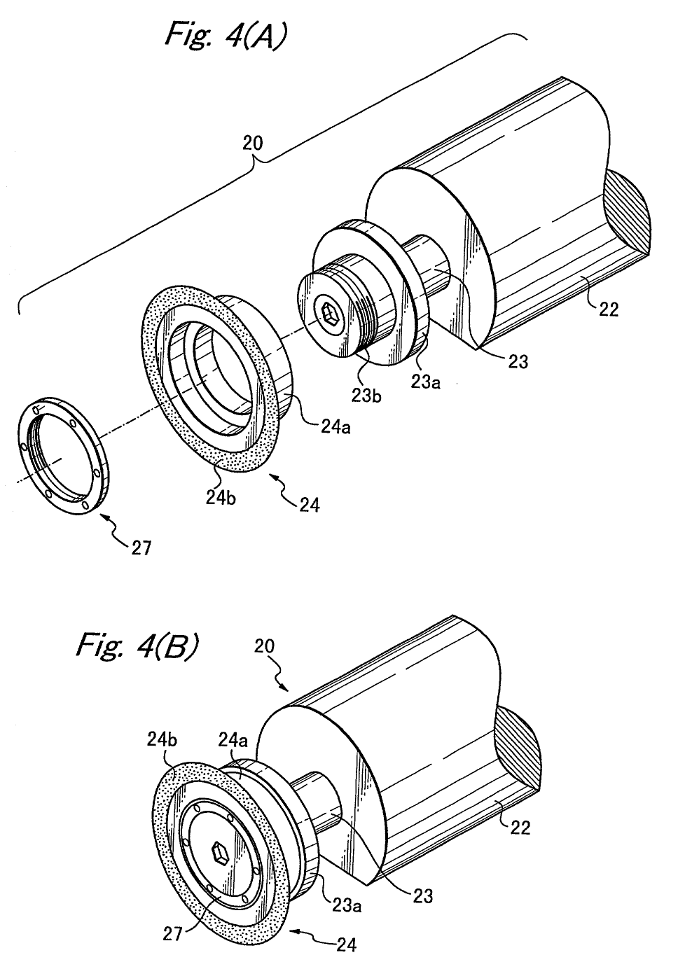

Referring to FIGS. 4(A) and 4(B), a base mount 23a is integrally connected to the first spindle 23 for supporting the first rotary blade 24, and male threads 23b are formed on the end of the first spindle 23. The first rotary blade 24 comprises a circular cutting blade 24b having a circular hole made at its center, and an annular hub 24a integrally connected to one side of the circular cutting blade 24b.

In mounting the first rotary blade 24 onto the first spindle 23, the rotary blade 24 is directed to the spindle 23 with its annular base 24a facing the male-threaded end of the spindle 23, and the male-threaded end is inserted in the center hole of the rotary blade 24 until the annular hub 24a abut on the base mount 23a of the spindle 23. Finally the nut 27 is tightened around the male-threaded end 23b of the collared spindle 23. As seen from FIG. 4(B), the nut 27 is fitted in the circular recess of the rotary blade 24, leaving nothing projecting outside. Thus, the rotary blade 24 is fixedly mounted to the spindle 23.

Similarly the second rotary blade 61 is fixedly mounted to the second spindle 60.

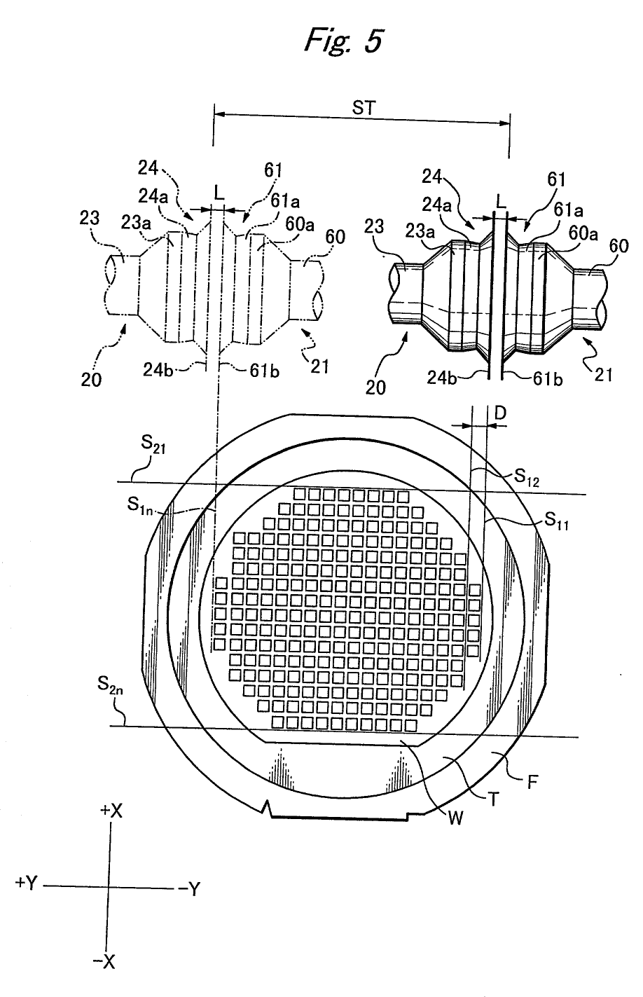

The manner in which a semiconductor wafer W is cut into a plurality of chamfered squares is described. The semiconductor wafer W is diced by making a “V”-shaped groove on each and every street and by cutting deep in each and every “V”-shaped groove to separate the wafer W, and then, the semiconductor wafer W is rotated 90 degrees to be “V”-grooved and cut into chamfered squares. Referring to FIG. 5, the cutting blade 24b of the first rotary blade 24 has a “V”-shape in its cross section for making a “V”-shaped groove in the workpiece whereas the cutting blade 61b of the second rotary blade 61 has a sharp straight-shape in its cross section for cutting deep in the thickness of the workpiece. The center axes of the first and second spindles 23 and 60 are aligned in line, allowing the first and second blades 24b and 61b to face each other.

Referring to FIGS. 1 and 5, first, the chuck table 11 is moved in the +X-axial direction, and at the same time, the first alignment means 28 is moved in the −Y-axial direction until the alignment means 28 has been put above the semiconductor wafer W, and then the picture of the wafer surface is taken to detect the street S₁₁ to be cut first. Then, the cutting blade 24b of the rotary blade 24 of the first cutting means 20 is aligned with the street S₁₁ in the Y-axial direction.

The second Y-axial screw rod 39 is rotated by the second stepping motor 41 so that the second cutting means 21 is moved in the +Y-axial direction. The second cutting means 21 is made to stop when the second cutting blade 61b is the street-to-street distance D apart from the first cutting blade 24b in the −Y-axial direction.

After positioning the first and second cutting blades 24b and 61b with respect to the street S₁₁, the chuck table 11 is moved in the +X-axial direction, and at the same time, the first cutting blade 24b is lowered a predetermined distance while rotating at an increased speed, so that a “V”-shaped groove is made on the street S₁₁.

Then, the first and second cutting means 20 and 21 are moved the street-to-street distance D in the +Y-direction to put the first and second cutting blades 24b and 61b in alignment with the streets S₁₂ and S₁₁ respectively.

After positioning the first and second cutting blades 24b and 61b with respect to the streets S₁₂ and S₁₁ respectively the chuck table 11 is moved in the −X-axial direction, and at the same time, the first and second cutting means 20 and 60 are lowered while rotating at an increased speed, so that the cutting blade 24b makes a “V”-shaped groove on the street S₁₂ and so that the cutting blade 61b cuts the “V”-shaped groove deep to its bottom on the street S₁₁.

Then, the first and second cutting means 20 and 21 are moved the street-to-street distance D in the +Y-axial direction to put the first and second cutting blades 24b and 61b in alignment with the streets S₁₂ and S₁₁ respectively.

The first cutting blade 24b cuts a predetermined depth on the street S₁₃ to make a “V”-shaped groove, and at the same time, the second cutting blade 61b cuts the street S₁₂ deep enough to reach the bottom of the “V”-shaped groove.

The first and second cutting means 20 and 21 are indented and fed the distance D to chamfer and cut the remaining streets S₁₁ to S₁ₙ sequentially. When the first and second cutting means 20 and 21 cut the semiconductor wafer W sequentially across the semiconductor wafer W to reach the final X-axial linear position (see the vertical two-dot and one-dash line in FIG. 5), all the streets S₁₁ to S₁ₙ are chamfered and cut. Each rotating blade 24b or 61b is moved with a stroke of ST.

The chuck table 11 is rotated 90 degrees to perform the same chamfering and cutting as described above to chamfer and cut the streets S₂₁ to S₂ₙ sequentially. Thus, the semiconductor wafer W is cut crosswise into a plurality chamfered squares.

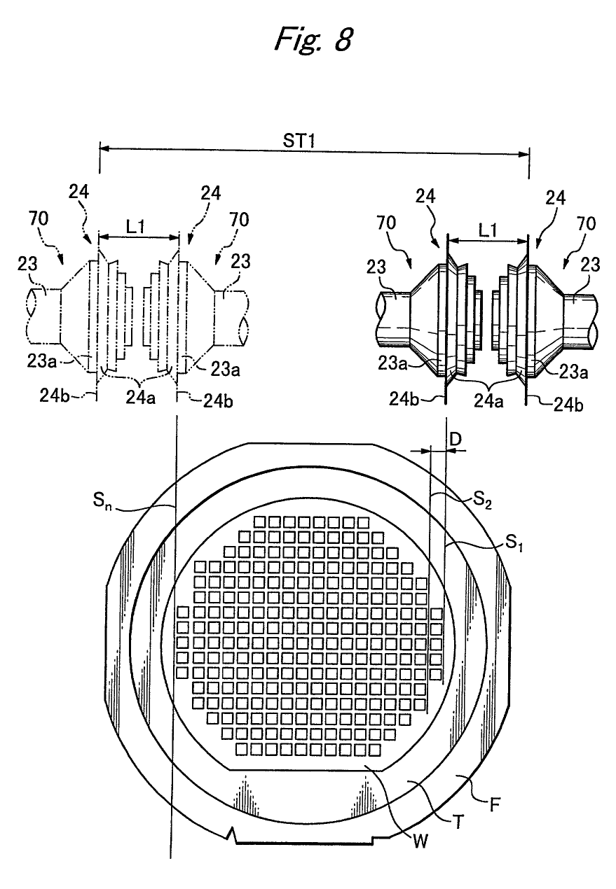

As may be understood from the above, the rotary blades of the opposing spindles can be made to confront without nothing intervening therebetween, and therefore, the confronting rotary blades can be moved toward each other, leaving as short a distance as the street-to-street distance D, no matter how short the street-to-street distance D may be. Thus, two adjacent streets can be chamfered and cut simultaneously except for the first and last streets. The stroke ST can be shorter than the stroke ST1 in the conventional cutting machine (see FIG. 8), and accordingly the dicing can be made at an increased efficiency.

In dicing, cooling water is supplied to the cutting area as seen from FIG. 3. In the drawing, a water jet nozzle 25 is placed behind the rotary blade 24 on the side of the annular hub 24a. Likewise, another jet nozzle (not shown) is placed behind the rotary blade 61 on the side of the annular hub 61a. Each water jet nozzle 25 is placed to be close to the cutting blade 24b or 61b, still leaving such a significant distance apart therefrom that no hindrance may be caused to adjustment of the blade-to-blade distance between the confronting cutting blades 24b and 61b, and that no interference may be caused in the cutting operation.

As shown in FIG. 3, there is provided a blade defect detecting means behind the rotary blade 24 of the first cutting means 20 on the side of the annular hub 24a. It comprises a light-emitting element 26a and a light-receiving element 26b to detect defects, such as wear or break, if any on the cutting blade. Specifically, the beam of light throwing from the light-emitting element 26a impinges on the cutting blade 24b, and the beam of light is reflected from the cutting blade 24b to fall on the light-receiving element 26b. The wear or break can be detected in terms of reduction in the amount of light falling on the light-receiving element 26b. Likewise, the second cutting means 61 has a similar blade defect detecting means, although not shown.

The blade defect detecting means is placed on the side of the annular hub 24a or 61a of each rotary blade, so that either rotary blade can be moved close to the counter rotary blade. No matter how short the street-to-street distance D may be, two adjacent streets can be chamfered and cut simultaneously, and then, defects on the cutting blade, if any can be detected at once.

A cutting machine according to the present invention is described as chamfering and cutting the streets on the semiconductor wafer. In a case where the semiconductor wafer is diced without chamfering, linear cutting blades are mounted to the first and second spindles to permit simultaneous cutting of two adjacent streets by making the first and second cutting means 20 and 21 to move twice as large as the street-to-street distance D. Accordingly the dicing efficiency is substantially improved.

What is claimed is:

1. A cutting machine comprising at least a chuck table for fixedly holding a workpiece to be cut, an X-axial feeder means for feeding the chuck table bearing the workpiece thereon in X-axial direction, and first and second cutting means each having a spindle arranged in Y-axial direction, perpendicular to the X-axial direction, said first and second cutting means being so arranged that rotary axes of the spindles may be aligned with each other with their rotary blades facing each other, wherein each rotary blade comprises a circular cutting blade having an annular hub integrally connected to one side; each spindle has the rotary blade mounted with its hub directed inside, leaving no projection outside, thus permitting each cutting blade to face the counter cutting blade without anything intervening therebetween; and the cutting machine further comprises water jet nozzle means in the vicinity of the rotary blade.

2. A cutting machine according to claim 1, wherein it further includes blade defect detecting means comprising light emitting and light receiving elements so arranged on the side of the annular hub of each rotary blade that the beam of light from the light emitter may reach the light receiver after being reflected from the rotary blade.
